(19) United States
(12) Patent Application Publication
(10) Pub. No.: US 2004/0176989 A1
(43) Pub. Date: Sep. 9, 2004

(54) Method for raising funds

(76) Inventor: James J. Darr, Greenwich, CT (US)

Correspondence Address: PATTON BOGGS LLP, ATTORNEYS AT LAW, 2550 M Street, NW, Washington, DC, 20037-1350, US

(21) Appl. No.: 10/382,947

(22) Filed: Mar. 7, 2003

(51) Int. Cl. G06F 17/60

(52) U.S. Cl. 705/4

(57) ABSTRACT

A method for raising funds includes taking out life insurance on insurable interests of a first organization and naming the first organization as beneficiary of the life insurance. The method also includes transferring rights and/or benefits from the life insurance on the insurable interests to at least a second organization to raise funds for at least the first organization and/or the second organization.

### FIELD OF THE INVENTION

The present invention relates to a fund raising program. More particularly, the present invention relates to a fund raising program for non-profit organizations utilizing life insurance.

### DESCRIPTION OF BACKGROUND INFORMATION

Presently, a need exists to develop and employ programs that offer the potential to raise funds for non-profit organizations (“NPO”), for example, without the NPOs having to ask for more cash and/or capital asset donations from their members.

### BRIEF DESCRIPTION OF THE DRAWINGS

FIG. 1 depicts one exemplary embodiment of a method for raising funds.

### DETAILED DESCRIPTION

One embodiment of the present invention provides a program that may include a structured financial transaction (and/or may not be a single security or a cash in vs. cash value equivalent). The structured transaction may include several components and each of the components has value. The program may ensure the financial viability of one or more non-profit organizations including, for example, educational, religious, and/or charitable organizations.

The program provides benefits from mortality distributions that may not be obtained without ownership of insurable interests. Insurable interests may trigger the cash flows and the duration of the structured financial asset, as well as create a ratable and more secure component value to part of the asset depending upon the rating of the underlying insurance company. Institutions may not manufacture or acquire insurable interests for the purpose of insuring them. Only an organization such as, for example, an NPO, with defined legal rights to an insurable interest in an individual can undertake to insure them.

The program may create the aggregation, for example, of large numbers of life risks. The program may provide benefits to the NPO, for example, through the sale of the cash flows resulting from the mortality rate of the aggregated insured interests and/or the underling investment performance and/or guarantees that may exist within an insurance policy(ies). Under the program, the NPO may accelerate receipt of future cash flow benefits from the aggregated insured interests by transferring, for example, through sale, use, control, assignment, and/or license, the future cash flow benefits and/or other rights and benefits, in whole or in part, to buyers (e.g, third-party and/or affiliated buyers). The program allows the NPO to realize, at least, in whole or in part, a present value of its future cash flow benefits.

In order to participate in the program, institutions may do so from an owner legally entitled to the insurable interests such as, for example, NPOs. The institutional buyer's valuation of the purchase price of the program may be based upon the program's ability to meet their needs and their valuation of each of its components.

Under the program, insurable interests may give consent to a NPO to allow themselves to be individually insured by the NPO, for example, for approximately $250,000.00 each. The insurable interests may include individuals associated with the NPO such as, for example, donors, employees, members, parishioners and/or friends of the NPO. The insurable interests may also include the category of individuals in whom the participating NPO has an interest, for example, under the Internal Revenue Code (“IRC”) and/or state code.

The insurer may be an offshore company and the closing of the policy(ies) may occur offshore. The definition of insurable interests may include that of the jurisdiction of closing such as, for example, Bermuda.

The insureds may agree to permit the NPO to take out the policy(ies) on their lives with the NPO named as the beneficiary. The insureds may irrevocably gift this right and the benefits associated with it to the NPO. Premiums may then be the sole responsibility of the NPO. The insureds may also grant the NPO, for example, the right to transfer (e.g., sell, use, control, assign, and/or license) the policy(ies), a net cash flow from the policy(ies), and/or other rights and/or benefits at the NPO's discretion. Over the term of the policy(ies) (e.g., approx. 60 years), the policy(ies) produces cash flow from death benefits and additional earnings dependant upon its structure. The policies may be aggregated into a group covering, for example, a minimum of 1,000 lives. Premiums on the policy(ies) may be paid by the NPO. The insureds may have no obligations for any of the premium payments on their policy.

Under the program, the NPO may provide, for example, through a sale, the net cash flow benefits of the policy and/or the policies to one or more institutions. The buyer may provide the funding for the premium payments and/or additional payment to the NPO. The buyer of the cash flow benefits may also have additional rights that may provide, for example, facilities for borrowing, cancellation of the policy(ies) and/or distribution of funds, and/or the right to sell and/or assign all or part of the policy(ies). The NPO may have no obligation to make premium payments in order to keep the policy(ies) in force.

The buyer may purchase the policy(ies) at an internal rate of return and/or present value. The policy(ies) may be structured as fully qualified life insurance and/or any other type of life insurance. The proceeds from the sale may include the payment of premiums, for example, for year one and the present valued contribution to the NPO, and a guarantee of payment of premiums, for example, for year two. Following the initial premium payments, which may cover all premiums for the first five years (or more or less), the periodic death benefits and additional pro rata earnings may be first applied to the payment of premiums due. The remaining amount may form the basis for annual net cash flows paid to the buyer. The sale may also provide for the payment of premiums for year one and a guarantee of premium payments for a predetermined number of years.

The policy(ies) may also be structured as a Modified Endowment Contract (“MEC”). The proceeds from the sale may include the single first year premium and the present valued contribution to the NPO. Following the single premium payment, the periodic death benefits and additional pro rata earnings may form the basis for annual cash flows paid to the buyer.

The NPO may also provide the funding for the initial insurance premiums, in whole or in part, including binders for the purchase of the policy(ies), for example, from its own funds (e.g., capital, loans, gifts, etc.).

The Program may spread income (e.g., net of insurance premiums and expenses) to the owner/beneficiary(ies) of the policy(ies), for example, in annual installments over approximately sixty years (or more or less). Net cash flow after payment of the premiums to the owner/beneficiary may be lower, for example, in the first 25-30 years and higher in the last 30-35 years dependant upon, for example, the age of the insureds, their mortality rate, and/or the investment performance of the separate account and/or guarantees of the insurance company.

The NPO may choose to hold the policy(ies) and collect the income stream from the policy(ies) death benefits and earnings, for example, over the approximate sixty-year term. The NPO may also choose to accelerate receipt of the cash flow benefits from the policy(ies) by selling the cash flow benefits to one or more buyers (e.g., an institutional buyer).

If the NPO elects to sell the cash flow benefits, the sale price of the policy(ies) may be based upon the internal rate of return (“IRR”) and/or present value of the policy(ies)'s cash flow benefits, for example, over the approximate sixty years as determined by the buyer. The proceeds from the sale of the policy(ies) may be used to pay fees and expenses and/or the NPO. The sale price may be determined by the interest rates and other market conditions prevailing at the time the policy(ies) are sold.

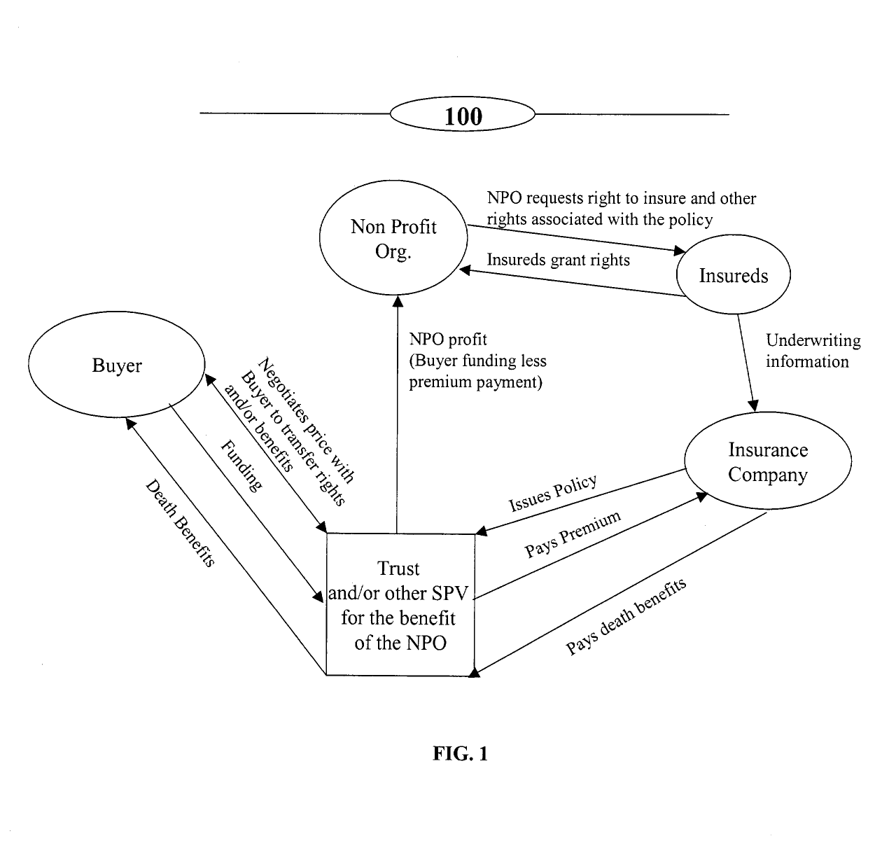

The acts to implement one exemplary embodiment of the program (see, for example, FIG. 1) may include:

Identification of qualified insureds in a NPO;

Requesting the insureds to enroll in the program;

Completion by the insureds of an application that provides information pertinent to the ability of the insurance company to underwrite the insurance policy and permits the NPO to take out a policy(ies) naming itself as beneficiary and granting it the irrevocable right to utilize the policy(ies) as it determines would be in its best interests;

Selecting insureds, for example, in groups of 1,000 (or more or less), for example, who meet a standard of good health, distribution of ages, etc. (e.g, from an actuarial matrix and/or formula);

Payment of premiums, in whole or in part (e.g., the initial premiums), including binders for the purchase of the policy(ies), for example, by the NPO from its own funds and/or through financing arranged with one or more institutions;

Sale of the cash flows, other rights and benefits and/or the policy(ies); and/or

Payment to the NPO of the difference between the sale price of the policy(ies) and the initial premium or premiums, less fees and expenses.

The program may be divided into one or more parts such as:

1. Insurance Policy(ies);

2. Institutional Sales of the Policy(ies); and/or

3. NPO Marketing.

Insurance Policy(ies):

The program may include the MEC, the two year program and/or any other structured insurance policy (e.g., any type of structure life insurance policy such as, for example, an individual and/or group policy), whether Variable Universal Life, which utilizes the separate account, or a standard guaranteed policy where the insurance company holds the money in its General Account. Whatever the structure of the policy, the program may apply a process (see, for example, FIG. 1) to realize a gain for the NPO.

A NPO may take out a life insurance policy(ies) on its employees, contributors, etc., that qualify as insurable interests. Each individual may be insured for a minimum of approximately $250,000. The individual policies maybe aggregated into a group of 1000 lives (or more or less) that match an actuarial matrix/formula that provides the necessary expected mortality rate to give the institutional investors a predictable return. The policy(ies) may then be closed, aggregated into the groups of 1000 (or more or less), and also payment may be deferred for up to approximately 60 days (or more or less) to allow for the institutional funding to take place.

The policy(ies) may qualify as an insurance contract. It may be a variable universal life policy with annual premiums (“AP”) and/or a MEC with a single premium utilizing a separate account structure. The insurance company may guarantee death benefits so long as the policy(ies) remains in force. Death benefits may increase and/or decrease with the value of assets in the separate account.

The insurance companies may select money managers with suitable track records. The institutional buyer may have an input into the selection of the money managers investing the funds in the separate account. The policy(ies) may also utilize any other well-known account structure.

In an embodiment including the AP structure, premiums may be paid-in the first and second year (and/or other years). The first and second year premiums may be increased to the maximum amount allowed under Section 7702 of the IRC for a seven year pay in. No premium payments may then be made until year six (and/or any other year). At that time, death benefits may cover all premiums due plus provide positive cash flow until the termination of the Program, for example, in the 60^{th} year. Premiums under the variable policy may be subject to change according to investment experience within the policy.

The institutional funding may accommodate the two year premium pay-in. The buyer may pay in the total of the first year premium plus the present value spread and provide a guarantee for the second year premium.

In an embodiment including the MEC structure, the single premium may be the maximum amount allowed under Section 7702 of the IRC. The premium may be due at closing. This may be done through a trust vehicle.

The policy(ies) may remain in force with no additional premium so long as there is sufficient cash value within the policy(ies) to pay the expenses of the policy(ies).

Death benefits may consist of the standard death benefit (e.g., $250,000 (or more or less)). Total Death Benefits may be the standard death benefit (less any premium payments if applicable) plus the allocable portion of additional cash value. Death benefits may be greater than $250,000, for example, if investment performance is sufficiently positive.

The insurance company may assume responsibility for mortality tracking and/or other policy(ies) administration.

Institutional Sale:

The institution may acquire the net cash flows from the policy(ies) at an internal rate of return (“IRR”) and/or net present value (“NPV”) acceptable to the NPO and the institution. Total death benefits may be used to calculate this number, as well as other features and benefits that weigh in the value of the asset class of the program the institution(s) assign to ownership. These include:

A sale (e.g., assignment) for the net cash flows and/or certain rights and/or benefits and, for example, not a security under the '33 Act, and/or, if a security, may then be an unregistered security and/or a registered security;

May be booked as “other asset” and income booked as “other income”;

May be accounted for each year with a determined accrual;

May not be “marked-to-market”;

May be non-callable since the insurance policy(ies) may be non-callable;

Certain policy loan provisions, which rights can be enforced by the institutional buyer, allow for additional asset leverage;

The net cash flow and/or certain rights and benefits may be sold (e.g., assigned) to subsequent holders; and/or

An aftermarket may be developed.

Presently, a shortage of long-term rated income vehicles exists in the marketplace. Institutions requiring long-term income and asset diversification (such as, for example, pension funds, insurance companies, bond funds, banks, etc.) may be candidates for this product.

The institution may also choose to purchase the entire holding vehicle (e.g., trust) inclusive of the policy(ies). This may entail the issuance of a security by the NPO.

Non-Profit Organization Marketing:

The NPO may identify the qualified insureds, and contact (e.g., in conjunction with a third party) the insureds requesting them to permit the NPO to insure them. The insureds may fill out a form (e.g., a confidential short form) authorizing the NPO to take out the policy and name itself (or its assigns, e.g., the trust) the owner/beneficiary. The approval of the insureds may be irrevocable and permit the NPO to dispose of, hypothecate or otherwise utilize the policy or its benefits. The insureds may have no obligation and/or responsibilities for premium payments.

The insurance company may select individual insureds, for example, in groups of approximately 1,000 or more, to match an actuarial matrix/formula for each policy(ies). The insurance company may form the policy and/or group of policies in contemplation of closing, for example, within 60 days. The policy(ies) may be held in a trust and/or other special purpose vehicle that may be bankruptcy remote.

The net cash flow and/or other rights and/or benefits from the policy(ies) due to the NPO may be sold on an exclusive best efforts basis. Net cash flow may be the yearly death benefits minus the annual premium due if any. The difference between the sale price of the cash flows and/or other rights of the policy(ies) and the initial premiums may be paid to the NPO. The NPO may pay fees and expenses.

### Exemplary Features and Benefits

The program may include any and all types of insurance policies. The program may also include an offshore and/or a domestic carrier. In addition, the program may provide for the transfer, partially, exclusively, and/or wholly, of cash flows. The program, however, is not limited to that structure. The program may provide for the transfer, partially, exclusively, and/or wholly, of any and all rights and/or benefits in whatever form.

| | |
|---|---|
| Variable Life Insurance | The minimum death benefit of each insured may be |
| Policy | $250,000. The policy(ies) may cover a minimum of about |
| | 1000 lives; each admitted life may be subject to approval |
| | by the insurance company. The policy(ies) may qualify as |
| | a “life insurance contract” within the provisions of Section |
| | 7702 of the Internal Revenue Code or as a Modified |
| | Endowment Contract. |
| Mortality Assumptions | May be based upon actuarial tables. |
| Program Term | Approximately 60 years (until last insured dies or reaches |
| | maturity, age 100). |
| Macaulay Duration | Approximately 30-40 years. Defined as a measurement of the |
| | average time to receive all mortality income cash |
| | flows (adjusted for payments of premiums), weighted by |
| | each respective annual payout. |
| Minimum Death Benefit | $250,000,000 on 1,000 lives ($250,000 on each insured as |
| | long as the policy(ies) remains in force) |
| Total Death Benefits | $600,000,000-$800,000,000 per 1,000 lives (Estimated |
| | assuming a 7% annual net return). Results may depend |
| | upon average age of the insureds and the policy(ies) |
| | remaining in force. |
| Net Cash Flow | $525,000,000-$750,000,000 per 1,000 lives (Estimated |
| | assuming a 7% annual net return). Results may depend |
| | upon average age of the insureds, the structure of the |
| | policy(ies), and the policy(ies) remaining in force. |
| Program Purchase Price | $50,000,000-$80,000,000 (Approximate for MEC). |
| | Equivalent to an annual internal rate of return of |
| | approximately 6%-7% on the net cash flow. Results may |
| | depend upon average age of the insureds, and the |
| | policy(ies) remaining in force. |
| Premium Payments | The premiums may be sufficient to pay death benefits and |
| | create cash buildup (e.g., substantial cash buildup) within |
| | the policy(ies) (based upon assumed earnings assumptions |
| | within the separate account, and mortality assumptions). If |
| | the policy(ies) are structured as fully qualified life |
| | insurance, the proceeds from the sale may include the |
| | payment of premiums for year one and the present valued |
| | contribution to the NPO, and a guarantee of payment for |
| | year two. Following the initial premium payments, which |
| | may cover all premiums for the first five years, the |
| | periodic death benefits and additional pro rata earnings |
| | may be first applied to the payment of premiums due. |
| | These death benefits may cover all premiums due plus |
| | provide a positive cash flow until termination of the |
| | policy(ies), for example, in the 60^{th} year. The positive |
| | cash flow may form the basis for payments paid to the |
| | institution. If the policy(ies) are structured as a MEC, the |
| | proceeds from the sale may include the single first year |
| | premium and the present valued contribution to the NPO. |
| | Following the single premium payment, the periodic death |
| | benefits and additional pro rata earnings may form the |
| | basis for annual cash flows paid to the institution. |
| | Premiums in the variable life policy(ies) may not be |
| | guaranteed and may be subject to change according to |
| | investment experience within the policy. |
| Early Redemption | The program may be non-callable because the insurance |
| | policy(ies) may be non-callable by the insurance |
| | company. |
| Ownership | The NPO may be the owner/beneficiary of the policy(ies) |
| | through an established trust or other Special Purpose |
| | Vehicle (“SPV”) that is secured. The NPO, at closing, |
| | may convey all rights and benefits to net cash flow, and/or |
| | other rights and benefits to the capital assets contained |
| | within the policy(ies) to the institutional purchaser, for |
| | example, by a contract, trust, and/or security. The |
| | insurance policy(ies) may be non-cancelable so long as |
| | positive cash value is maintained. The institution may |
| | demand cancellation and/or distribution of assets, for |
| | example, at any time. The institution may hold the |
| | contract, the trust, and/or the security, or sell it in whole or |
| | in part at its discretion. |
| Separate Account | The cash values of the policy(ies) may be funded by a |
| | separate account of the life insurance company and may |
| | not be subject to claims of its creditors. The separate |
| | account may contain investment managers and/or assets |
| | approved by the life insurance company. Such funds may |
| | be moved among sub accounts of the separate account, for |
| | example, without incurring a tax liability on behalf of the |
| | institution buyer. As a result, investment strategies such as |
| | dollar cost averaging, asset allocation, and other |
| | rebalancing can be achieved with a maximum of |
| | flexibility and without the burden of expense and taxation |
| | as these events may occur. |
| Assumed Internal Return | 7.00% net. Internal return assumption can be varied. For |
| Within the Policy(ies) | illustrative purposes, a 7% net return over the lifetime of |
| | the program is assumed. |
| Net Cash Flow Income | May be treated as taxable. |
| Policy Loans | The investor may take out periodic policy loans, for |
| | example, for any number up to 100% (e.g., up to 90%) of |
| | the accumulated and unencumbered cash value. Upon the |
| | event of a policy loan, the insurance company may move |
| | the indicated amount to a loan guarantee account that may |
| | not be subject to market risk. Specific provisions |
| | regarding this aspect of the policy(ies) may be subject to |
| | the provisions as outlined in the life insurance policy(ies). |
| Cash Value | The accumulated cash value of the policy(ies) may vary to |
| | reflect the investment performance of the fund |
| | manager(s). The face amount (e.g., $250,000,000 per |
| | 1,000 lives) may be maintained at all times provided that |
| | positive cash value is maintained during the program |
| | period (e.g., approximately 60 years). If the investment |
| | experience is sufficiently positive, the death benefit may |
| | be adjusted upward, reflecting that investment experience. |
| | If negative, the death benefit may be adjusted downward, |
| | for example, not below the face amount of the original |
| | program (e.g., $250,000,000). |
| Transferability | The program may be, in whole or in part, transferable. |
| Servicing | The insurance company may provide for mortality |
| | tracking and other policy administration. |
| Accounting Procedure | Institutions (e.g., financial institutions) may account for |
| | this transaction as a purchase of cash flows. The benefits |
| | to the institutions may not be marked-to-market based |
| | upon the value of the underlying securities in the separate |
| | account. The institutions may book the benefits at |
| | purchase price. Based on the anticipated earnings rate at |
| | time of purchase, the institutions may credit interest at the |
| | purchase rate each year, subtract actual cash distributions, |
| | and add the net amount to the previous year's booked |
| | value. The asset may be booked on an accrual basis. |
| Off-Shore Variable Life | The insurance carrier may provide a list of external |
| Insurance Policy Options | managers that may allow the program purchaser a broad |
| | range of investment options. The program purchaser may |
| | be in a position to influence investment performance by |
| | recommending approved asset managers that meet its |
| | investment criteria. The program may include features that |
| | positively impact potential returns and minimize frictional |
| | costs. These may include: |
| | The insurance carrier may be a non-US carrier that |
| | enjoys the benefits of lower levels of taxation. This |
| | allows it to develop products with greater flexibility |
| | and lower costs. |
| | Sub account options may include a broad spectrum of |
| | asset managers and strategies that may not be |
| | available with insurance companies that retain all asset |
| | management internally. |
| Benefits | Investment diversification and flexibility (unique to |
| | variable life insurance policy); |
| | Separate account is not subject to claims of general |
| | creditors in the event of a default by the carrier; |
| | Flexible investment options available in the separate |
| | account; |
| | Dividends, capital gains and interest generated in the |
| | separate account are not taxable; |
| | Sale of one asset within the separate account and |
| | purchase of another is not a taxable event; |
| | Policy loans can be taken out for up to 90% (or more |
| | or less) of the accumulated cash value and |
| | withdrawals are permitted; |
| | Asset is non-callable; |
| | Asset does not have to be marked-to-market; and/or |
| | Asset can be parsed or transferred to another owner at |
| | the option of the holder. |

Presently, institutions need:

long-term duration assets;

asset mix that provides predictability and security of cash flows;

security of collateral value;

duration and cash flow match long-term liabilities (e.g. retirement benefits, etc.);

non-callable asset;

no reinvestment decisions exterior to the asset that result in a reallocation of portfolio funds;

flexible investment parameters for funds within the asset;

favorable accounting treatment;

favorable tax treatment; and

diversification in the overall portfolio into non-securities assets.

In comparison, one exemplary embodiment of a structured financial asset may include:

Long term duration (e.g., 30-40 years Macauley).

Asset mix may be a combination of invested securities and expected mortality payments based upon established actuarial tables/formula. Cash distributions may be based upon and timed by mortality payments. As long as the policy(ies) remains in force, a rated insurance company may guarantee the face amount. The mortality payments part of the cash flow may include a safety component independent from the securities in the separate account.

Approximately 75%-95% (or more or less) collateralization on day one with 100% (or more or less) collateralization from the second year forward. Immediate return of collateral upon request. (By comparison, long term litigation upon failure of a corporate bond. Most corporations that issue bonds have an average leverage of 2:1 debt vs. equity, i.e., a collateralization of 33%. Such collateral is not liquid and may consist of plant, equipment, good will, etc. If there is a problem with the company, recovery is through the courts (usually in bankruptcy), behind other creditors, along with similar creditors led by the strongest. Recovery could take several years.) Liquidation of the underlying assets under normal circumstances that is not significantly slower than liquidation of securities.

Cash flow curve and duration may match long-term liability issues.

The program may include no callable features (preserving duration).

Investment decisions may be made within the policy(ies). The portfolio manager does not have to make reinvestment decisions that create a reallocation of funds in the entire portfolio. (For example, for institutions that do not have large investment management operations, the cost of management of funds in the policy(ies) may be lower than creating fixed overhead costs within the institution).

The program may provide for maximum funding of the policy(ies) to create significant and higher than standard asset buildup within the policy(ies). Funds can be moved and reallocated within the policy(ies) by the insurance company according to the wishes of policy(ies) owner. The program holder may have investment rights within the policy(ies).

The program has favorable accounting treatment: rights and/or benefits may be booked and carried initially at purchase price; the book value may be increased each year using an accrual formula based upon assumed rates of return less actual cash distributions (the asset may not be “marked to market”); the transaction may be a transfer (e.g., sale, use, control, assignment, license), partially, exclusively and/or wholly, of rights and/or benefits (e.g., not a security within the definition of the Securities and Exchange Act of 1933) and may be booked as “other asset” and income may be booked as “other income.” and/or

Capital gains, dividends and/or interest income may accumulate tax free within the policy(ies).

In comparison, features of securities include:

there are few if any long duration assets available (e.g., 100 year bonds have a Macauley of 12-16 years);

portfolio manager creates asset mix and no corporate asset is as certain or predictable as mortality;

recovery of funds under adverse conditions is time consuming, expensive and uncertain. Liquidation under normal circumstances is minimally faster;

long-term liabilities are not easily matched with a single security purchase;

most long-term income securities are callable or subject to refunding;

require constant reallocation and reinvestment decisions affecting the entire portfolio;

funds can be moved and reallocated;

are “marked to market” reflecting immediate decreases or increases in valuation (In the event of a decrease, the portfolio manager is immediately judged on the loss.);

tax treatment is dependent upon the tax status of the institutional buyer; and

are not part of the required diversification into “other assets.”

FIG. 1 illustrates one exemplary implementation of a method 100 for raising funds. The method 100 may identify insurable interests associated with a NPO. The method 100 may request authorization for the NPO to insure the insurable interests. The method 100 may receive authorization for the NPO to insure the insurable interests. The method 100 may take out a life insurance policy (e.g., a group life insurance policy) or a plurality of life insurance policies (e.g., a plurality of individual life insurance policies) on the insurable interests associated with the NPO. The method 100 may name the NPO as beneficiary of the life insurance policy(ies). The method 100 may group (e.g., selectively pool) the plurality of life insurance policies. The method 100 may raise funds for the NPO from the life insurance on the insurable interests.

The life insurance policy(ies) may produce a cash flow over a term of the life insurance policy(ies), in part or in whole, from mortality payments. The method 100 may hold the life insurance policy(ies) in a vehicle that is bankruptcy remote. The method 100 may invest premium payments of the life insurance policy(ies), through an account (e.g., a separate account), in assets to produce the cash flow over the term of the life insurance policy(ies). The method 100 may transfer part or all of (i) the cash flow and/or other rights and benefits from the life insurance policy(ies), for example, through a contract, a trust, and/or a security, and/or (ii) the holding vehicle for the life insurance policy(ies) to at least a second organization to raise funds for the NPO and/or the second organization.

A machine-readable medium may include encoded information, which when read and executed by a machine causes, for example, the method 100 and/or described embodiments. The machine-readable medium may store programmable parameters and may also store information including executable instructions, non-programmable parameters, and/or other data. The machine-readable medium may comprise read-only memory (ROM), random-access memory (RAM), nonvolatile memory, an optical disk, a magnetic tape, and/or magnetic disk. The machine-readable medium may further include, for example, a carrier wave modulated, or otherwise manipulated, to convey instructions that can be read, demodulated/decoded and executed by the machine (e.g., a computer). The machine may comprise one or more microprocessors, microcontrollers, and/or other arrays of logic elements.

The foregoing presentation of the described embodiments is provided to enable any person skilled in the art to make or use the present invention. Various modifications to these embodiments are possible, and the generic principles presented herein may be applied to other embodiments as well. As such, the present invention is not intended to be limited to the embodiments shown above, any particular sequence of acts, and/or any particular configuration of hardware but rather is to be accorded the widest scope consistent with the principles and novel features disclosed in any fashion herein.

What is claimed is:

1. A method comprising:
taking out life insurance on insurable interests of a first organization and naming the first organization as beneficiary of the life insurance; and
transferring, partially, exclusively and/or wholly, one or more rights and/or benefits from the life insurance on the insurable interests to at least a second organization to raise funds for at least one of (i) the first organization and (ii) the second organization.

2. The method of claim 1, wherein the first organization is a non-profit organization.

3. The method of claim 2, wherein each of the insurable interests of the first organization is insured, through the life insurance, for about $250,000.

4. The method of claim 2, wherein the insurable interests include at least about 1000 lives.

5. The method of claim 2, wherein the insurable interests are grouped in relation with an expected mortality rate for the insurable interests.

6. The method of claim 2, wherein the term of the life insurance is about 60 years.

7. The method of claim 2, wherein the life insurance on the insurable interests includes a variable universal life insurance with annual premiums and a separate account structure.

8. The method of claim 7, further comprising
investing payments for the annual premiums, through the separate account, in assets to produce part or all of a cash flow from the life insurance on the insurable interests.

9. The method of claim 7,
wherein the annual premiums for the first five years of the life insurance on the insurable interests are paid in the first two years of the life insurance by at least one of (i) the first organization and (ii) the second organization, and
wherein the annual premiums for the years after the first five years of the life insurance are paid, in part or in whole, from mortality payments.

10. The method of claim 9, wherein the annual premiums are paid from the mortality payments after year six of the life insurance.

11. The method of claim 2, wherein the life insurance on the insurable interests includes a modified endowment contract with a single premium and a separate account structure.

12. The method of claim 11, further comprising
investing a payment for the single premium, through the separate account, in assets to produce part or all of a cash flow from the life insurance on the insurable interests.

13. The method of claim 2, wherein mortality payments from the life insurance on the insurable interests are guaranteed through an insurance company.

14. The method of claim 2, further comprising
investing premium payments of the life insurance on the insurable interests, through an account, in assets to produce part or all of a cash flow from the life insurance on the insurable interests.

15. The method of claim 14, wherein the assets include securities.

16. The method of claim 14, wherein the account is not subject to claims of creditors.

17. The method of claim 14, wherein capital gains, dividends, and interest income generated in the account from the assets accumulate tax free.

18. The method of claim 14, wherein the sale of one asset within the account and the purchase of another asset is not taxable.

19. The method of claim 14, wherein the second organization can borrow from the account.

20. The method of claim 19, wherein the second organization can borrow up to 90% of an accumulated and unencumbered cash value of the account.

21. The method of claim 1, wherein the life insurance on the insurable interests remains in force if a cash value is maintained from the life insurance.

22. The method of claim 1, wherein the life insurance on the insurable interests includes one or more life insurance policies, guaranteed by an insurance company, with one or more general accounts.

23. The method of claim 2, wherein the one or more rights and/or benefits from the life insurance on the insurable interests includes a cash flow.

24. The method of claim 2, further comprising
transferring, partially, exclusively and/or wholly, the one or more rights and/or benefits from the life insurance on the insurable interests from the second organization to a third organization.

25. The method of claim 2, wherein one or more policies for the life insurance on the insurable interests is held in a vehicle that is bankruptcy remote.

26. The method of claim 25, wherein the vehicle is a trust.

27. The method of claim 2, wherein the insurable interests of the first organization irrevocably gift the rights and benefits of the life insurance to the first organization.

28. The method of claim 2, wherein the second organization provides funding for one or more premium payments of the life insurance to the first organization.

29. The method of claim 2, wherein the life insurance on the insurable interests is non-callable.

30. The method of claim 2, wherein the one or more rights and/or benefits from the life insurance on the insurable interests is booked at purchase price.

31. The method of claim 2, wherein the one or more rights and/or benefits from the life insurance on the insurable interests is booked on an accrual basis.

32. The method of claim 2, wherein the one or more rights and/or benefits from the life insurance on the insurable interests is accounted for annually in relation with assumed rates of return, less actual payment distributions, from the one or more rights and/or benefits.

33. The method of claim 2, wherein the one or more rights and/or benefits from the life insurance on the insurable interests is not marked-to-market.

34. The method of claim 2, wherein a Macaulay duration of one or more policies for the life insurance on the insurable interests is approximately from 30 to 40 years.

35. The method of claim 2, wherein the second organization, under the one or more rights and/or benefits, can require cancellation of the life insurance on the insurable interests.

36. A machine-readable medium having encoded information, which when read and executed by a machine causes a method comprising:
taking out life insurance on insurable interests of a first organization and naming the first organization as beneficiary of the life insurance; and
transferring, partially, exclusively and/or wholly, one or more rights and/or benefits from the life insurance on the insurable interests to at least a second organization to raise funds for at least one of (i) the first organization and (ii) the second organization.

37. The machine-readable medium of claim 36, wherein the first organization is a non-profit organization.

38. The machine-readable medium of claim 37, wherein each of the insurable interests of the first organization is insured, through the life insurance, for about $250,000.

39. The machine-readable medium of claim 37, wherein the insurable interests include at least about 1000 lives.

40. The machine-readable medium of claim 37, wherein the insurable interests are grouped in relation with an expected mortality rate for the insurable interests.

41. The machine-readable medium of claim 37, wherein the term of the life insurance is about 60 years.

42. The machine-readable medium of claim 37, wherein the life insurance on the insurable interests includes a variable universal life insurance with annual premiums and a separate account structure.

43. The machine-readable medium of claim 42, the method further comprising
investing payments for the annual premiums, through the separate account, in assets to produce part or all of a cash flow from the life insurance on the insurable interests.

44. The machine-readable medium of claim 42,
wherein the annual premiums for the first five years of the life insurance on the insurable interests are paid in the first two years of the life insurance by at least one of (i) the first organization and (ii) the second organization, and
wherein the annual premiums for the years after the first five years of the life insurance are paid, in part or in whole, from mortality payments.

45. The machine-readable medium of claim 44, wherein the annual premiums are paid from the mortality payments after year six of the life insurance.

46. The machine-readable medium of claim 37, wherein the life insurance on the insurable interests includes a modified endowment contract with a single premium and a separate account structure.

47. The machine-readable medium of claim 46, the method further comprising
investing a payment for the single premium, through the separate account, in assets to produce part or all of a cash flow from the life insurance on the insurable interests.

48. The machine-readable medium of claim 37, wherein mortality payments from the life insurance on the insurable interests are guaranteed through an insurance company.

49. The machine-readable medium of claim 37, the method further comprising
investing premium payments of the life insurance on the insurable interests, through an account, in assets to produce part or all of a cash flow from the life insurance on the insurable interests.

50. The machine-readable medium of claim 49, wherein the assets include securities.

51. The machine-readable medium of claim 49, wherein the account is not subject to claims of creditors.

52. The machine-readable medium of claim 49, wherein capital gains, dividends, and interest income generated in the account from the assets accumulate tax free.

53. The machine-readable medium of claim 49, wherein the sale of one asset within the account and the purchase of another asset is not taxable.

54. The machine-readable medium of claim 49, wherein the second organization can borrow from the account.

55. The machine-readable medium of claim 54, wherein the second organization can borrow up to 90% of an accumulated and unencumbered cash value of the account.

56. The machine-readable medium of claim 36, wherein the life insurance on the insurable interests remains in force if a cash value is maintained from the life insurance.

57. The machine-readable medium of claim 36, wherein the life insurance on the insurable interests includes one or more life insurance policies, guaranteed by an insurance company, with one or more general accounts.

58. The machine-readable medium of claim 37, wherein the one or more rights and/or benefits from the life insurance on the insurable interests includes a cash flow.

59. The machine-readable medium of claim 37, the method further comprising
transferring, partially, exclusively and/or wholly, the one or more rights and/or benefits from the life insurance on the insurable interests from the second organization to a third organization.

60. The machine-readable medium of claim 37, wherein one or more policies for the life insurance on the insurable interests is held in a vehicle that is bankruptcy remote.

61. The machine-readable medium of claim 60, wherein the vehicle is a trust.

62. The machine-readable medium of claim 37, wherein the insurable interests of the first organization irrevocably gift the rights and benefits of the life insurance to the first organization.

63. The machine-readable medium of claim 37, wherein the second organization provides funding for one or more premium payments of the life insurance to the first organization.

64. The machine-readable medium of claim 37, wherein the life insurance on the insurable interests is non-callable.

65. The machine-readable medium of claim 37, wherein the one or more rights and/or benefits from the life insurance on the insurable interests is booked at purchase price.

66. The machine-readable medium of claim 37, wherein the one or more rights and/or benefits from the life insurance on the insurable interests is booked on an accrual basis.

67. The machine-readable medium of claim 37, wherein the one or more rights and/or benefits from the life insurance on the insurable interests is accounted for annually in relation with assumed rates of return, less actual payment distributions, from the one or more rights and/or benefits.

68. The machine-readable medium of claim 37, wherein the one or more rights and/or benefits from the life insurance on the insurable interests is not marked-to-market.

69. The machine-readable medium of claim 37, wherein a Macaulay duration of one or more policies for the life insurance on the insurable interests is approximately from 30 to 40 years.

70. The machine-readable medium of claim 37, wherein the second organization, under the one or more rights and/or benefits, can require cancellation of the life insurance on the insurable interests.

71. A method comprising:
taking out insurance on insurable interests of a first organization;
holding a policy or a plurality of policies for the insurance on the insurable interests of the first organization in a vehicle that is bankruptcy remote; and
transferring, partially, exclusively and/or wholly, one or more rights and/or benefits from the holding vehicle to at least a second organization to raise funds for at least one of (i) the first organization and (ii) the second organization.

72. The method of claim 71, wherein the first organization is a non-profit organization.

73. The method of claim 72, wherein the insurance on the insurable interests includes life insurance.

74. The method of claim 73, wherein the life insurance includes variable universal life insurance.

75. The method of claim 73, wherein the life insurance includes a modified endowment contract.

76. The method of claim 73, wherein the policy or the plurality of policies for the life insurance is guaranteed by an insurance company.

77. The method of claim 73, wherein the policy or the plurality of policies for the life insurance includes one or more general accounts.

78. The method of claim 73, wherein the vehicle is a trust.

79. The method of claim 73, wherein the term of the life insurance on the insurable interests is about 60 years.

80. A machine-readable medium having encoded information, which when read and executed by a machine causes a method comprising:
taking out insurance on insurable interests of a first organization;
holding a policy or a plurality of policies for the insurance on the insurable interests of the first organization in a vehicle that is bankruptcy remote; and
transferring, partially, exclusively and/or wholly, one or more rights and/or benefits from the holding vehicle to at least a second organization to raise funds for at least one of (i) the first organization and (ii) the second organization.

81. The machine-readable medium of claim 80, wherein the first organization is a non-profit organization.

82. The machine-readable medium of claim 81, wherein the insurance on the insurable interests includes life insurance.

83. The machine-readable medium of claim 82, wherein the life insurance includes variable universal life insurance.

84. The machine-readable medium of claim 82, wherein the life insurance includes a modified endowment contract.

85. The machine-readable medium of claim 82, wherein the policy or the plurality of policies for the life insurance is guaranteed by an insurance company.

86. The machine-readable medium of claim 82, wherein the policy or the plurality of policies for the life insurance includes one or more general accounts.

87. The machine-readable medium of claim 82, wherein the vehicle is a trust.

88. The machine-readable medium of claim 82, wherein the term of the life insurance on the insurable interests is about 60 years.

89. A method comprising:
identifying insurable interests of a non-profit organization;
taking out life insurance on the insurable interests of the non-profit organization depending upon an expected mortality rate for the insurable interests; and
raising funds for the non-profit organization from the life insurance on the insurable interests.

90. The method of claim 89, wherein the insurable interests include at least about 1000 individuals.

91. The method of claim 89, wherein the term of the life insurance is about 60 years.

92. The method of claim 89, wherein the life insurance includes a variable universal life insurance.

93. The method of claim 89, wherein the life insurance includes a modified endowment contract.

94. The method of claim 89, wherein the life insurance is guaranteed by an insurance company.

95. The method of claim 89, wherein a policy or a plurality of policies for the life insurance on the insurable interests includes one or more general accounts.

96. A method comprising:
taking out insurance on insurable interests associated with a first organization; and
raising funds for at least the first organization by transferring, partially, exclusively and/or wholly, at least a right and/or a benefit from the insurance on the insurable interests to at least a second organization.

97. The method of claim 96, wherein the first organization is a non-profit organization.

98. The method of claim 97, wherein the insurance on the insurable interests includes life insurance.

99. The method of claim 98, wherein the right and/or the benefit includes a cash flow from the insurance on the insurance policies.

100. The method of claim 98, wherein the right and/or the benefit from the insurance on the insurable interests is transferred, through a contract, to at least the second organization.

101. The method of claim 98, wherein the right and/or the benefit from the insurance on the insurable interests is transferred, through a trust, to at least the second organization.

102. The method of claim 98, wherein the right and/or the benefit from the insurance on the insurable interests is transferred, through a security, to at least the second organization.
